(19) United States
(12) Patent Application Publication
(10) Pub. No.: US 2014/0105417 A1
(43) Pub. Date: Apr. 17, 2014

(54) AUDIO SIGNAL PLAYBACK SYSTEM AND ELECTRONIC DEVICE

(71) Applicant: Huawei Technologies Co., Ltd., Shenzhen (CN)

(72) Inventor: Qiaoqiao CHENG, Hangzhou (CN)

(73) Assignee: Huawei Technologies Co., Ltd., Shenzhen (CN)

(21) Appl. No.: 14/141,048

(22) Filed: Dec. 26, 2013

Related U.S. Application Data
(63) Continuation of application No. PCT/CN2013/071921, filed on Feb. 27, 2013.

(30) Foreign Application Priority Data
May 25, 2012 (CN) 201210165488.4

(51) Int. Cl. H04R 3/04

(52) U.S. Cl. CPC H04R 3/04
USPC 381/96

(57) ABSTRACT

The present invention relates to the field of signal processing technologies, and provides an audio signal playback system and an electronic device. The system includes: two or more loudspeakers, configured to separately play audio signals in different frequency bands; a filter unit, configured to filter an input audio signal, amplify the filtered audio signal, and output the amplified audio signal to the two or more loudspeakers; and a feedback control unit, configured to collect the audio signals played by the two or more loudspeakers, measure power values of the audio signals in different frequency bands, and adjust, according to an measurement result, a amplification factor of the filter unit for the filtered audio signal in a corresponding frequency band.

### CROSS-REFERENCE TO RELATED APPLICATION

This application is a continuation of International Patent Application No. PCT/CN2013/071921, filed on Feb. 27, 2013, which claims priority to Chinese Patent Application No. 201210165488.4, filed on May 25, 2012, both of which are hereby incorporated by reference in their entireties.

### TECHNICAL FIELD

The present invention relates to the field of signal processing technologies, and in particular, to an audio signal playback system and an electronic device.

### BACKGROUND

It is known that human ears can hear an audio signal in a frequency range of 20 Hz to 20 KHz, and are especially sensitive to a low frequency part of an audio signal. To enable a loudspeaker to simultaneously produce better bass sounds and have a good treble performance, a conventional method is to increase loudspeaker size. For example, a loudspeaker with a diameter of 52 mm and a height of 26 mm has a relatively good performance in a low frequency part of around 160 Hz. However, along with the miniaturization of electronic devices, the space that can be occupied by a loudspeaker in an electronic device becomes increasingly smaller, and it is difficult to apply a large-size loudspeaker to most electronic devices.

To optimize the quality of audio signal playback without increasing the space occupied by a loudspeaker, the prior art provides an audio signal playback system. The audio signal playback system includes two or more loudspeakers with different frequency response ranges, and the two or more loudspeakers coordinate with each other to implement playback of an audio signal in a relatively wide frequency range. For example, the audio signal playback system may include two loudspeakers, where the frequency response range of one loudspeaker is 50 Hz to 3000 Hz, and the frequency response range of the other loudspeaker is 1000 Hz to 12 KHz; and an audio signal to be played is directly input into the two loudspeakers for playback.

However, due to different frequency response ranges, a problem of inconsistent loudness easily occurs among the loudspeakers in the audio signal playback system: when the loudspeaker with the frequency response range in a relatively high frequency band is louder, human ears cannot hear an audio signal played by the loudspeaker with the frequency response range in a relatively low frequency band, and vice versa. As a result, the quality of audio signal playback is poor, and the experience of a listener is poor, which is not conducive to the promotion and application of a product.

### SUMMARY

An objective of embodiments of the present invention is to provide an audio signal playback system, so as to solve a problem of poor playback quality in an audio signal playback system provided in the prior art, where the audio playback system has two or more loudspeakers with different frequency responses and inconsistent loudness easily occurs among the loudspeakers.

The embodiments of the present invention are implemented as follows: An audio signal playback system includes:
two or more loudspeakers, configured to separately play audio signals in different frequency bands;
a filter unit, configured to filter an input audio signal, amplify the filtered audio signal, and output the amplified audio signal to the two or more loudspeakers; and
a feedback control unit, configured to collect the audio signals played by the two or more loudspeakers, measure power values of the collected audio signals in different frequency bands, and adjust, according to a measurement result, an amplification factor of the filter unit for the filtered audio signal in a corresponding frequency band.

Another objective of the embodiments of the present invention is to provide an electronic device, and the electronic device includes an audio signal playback system described above.

The audio signal playback system provided in the embodiments of the present invention, besides including two or more loudspeakers, further includes a feedback control unit for performing frequency analysis on audio signals emitted by the loudspeakers and adjusting, according to an analysis result, audio playback strength of a corresponding loudspeaker. In this way, feedback control over audio playback strength of the loudspeakers is implemented, so that the loudspeakers have consistent loudness, thereby optimizing the audio playback quality of the system, improving the experience of a listener, and facilitating the promotion and application of a product.

### BRIEF DESCRIPTION OF DRAWINGS

FIG. 1 is a structural diagram of an audio signal playback system according to an embodiment of the present invention;

FIG. 2 is a structural diagram of a filter unit in FIG. 1;

FIG. 3 is a structural diagram of a feedback control unit in FIG. 2;

FIG. 4 is a structural diagram of a digital signal processing module in FIG. 3;

FIG. 5 is a schematic diagram illustrating an exterior of an electronic device, which is a telephone, according to an embodiment of the present invention; and

FIG. 6 is a schematic diagram illustrating an exterior of an electronic device, which is a mobile communication terminal, according to an embodiment of the present invention.

### DESCRIPTION OF EMBODIMENTS

To make the objectives, technical solutions, and advantages of the present invention more comprehensible, the following further describes the present invention in detail with reference to the accompanying drawings and embodiments. It should be understood that, the embodiments described herein are merely used to explain the present invention, but not intended to limit the present invention.

To solve the problem existing in the prior art, an audio signal playback system provided by the embodiments of the present invention, besides including conventional two or more loudspeakers with different frequency response ranges, further includes a feedback control unit for performing frequency analysis on audio signals emitted by the loudspeakers and adjusting, according to an analysis result, audio playback strength of a corresponding loudspeaker.

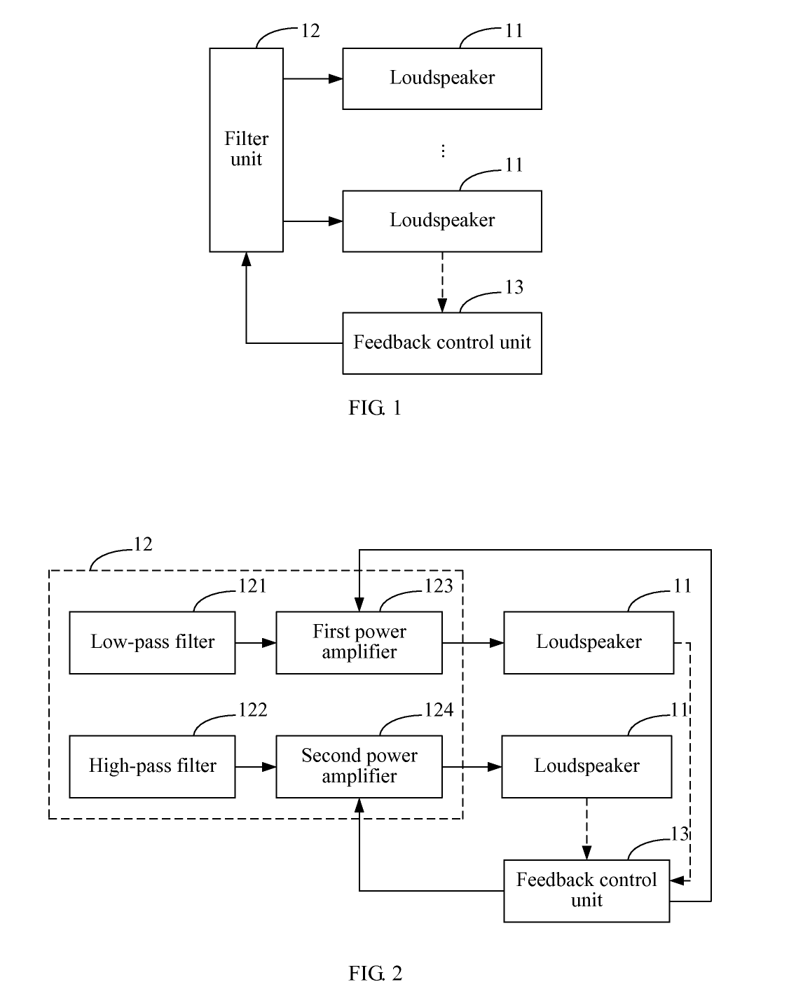

FIG. 1 shows a structure of an audio signal playback system according to an embodiment of the present invention, and for ease of description, only a part related to the embodiment of the present invention is shown.

The audio signal playback system provided in the embodiment of the present invention includes: two or more loudspeakers 11, where the two or more loudspeakers 11 have different frequency response ranges and are configured to separately play audio signals in different frequency bands; and a filter unit 12, configured to filter an input audio signal, amplify the filtered audio signal, and output the amplified audio signal to the two or more loudspeakers 11, so as to avoid the problem that reverberation easily occurs when multiple loudspeakers 11 play audio signals. Different from a conventional audio signal playback system, the audio signal playback system provided in the embodiment of the present invention further includes: a feedback control unit 13, configured to collect the audio signals played by the two or more loudspeakers 11, measure power values of the collected audio signals in different frequency bands, and adjust, according to a measurement result, an amplification factor of the filter unit 12 for the filtered audio signal in a corresponding frequency band.

Different from the prior art, the audio signal playback system provided in the embodiment of the present invention, besides including two or more loudspeakers, further includes a feedback control unit for performing frequency analysis on audio signals emitted by the loudspeakers and adjusting, according to an analysis result, audio playback strength of a corresponding loudspeaker. In this way, feedback control over audio playback strength of the loudspeakers is implemented, so that the loudspeakers have consistent loudness, thereby optimizing the audio playback quality of the system, improving the experience of a listener, and facilitating the promotion and application of a product.

The filter unit 12 may include: two or more filters, configured to separately filter an input audio signal, and output the filtered audio signal; and two or more power amplifiers, where the two or more power amplifiers are separately connected in one-to-one correspondence between the filters and loudspeakers, and are configured to amplify the audio signals output by the corresponding filters, and output the amplified audio signals to the corresponding loudspeakers.

For example, when the audio signal playback system provided in the embodiment of the present invention includes two loudspeakers 11, as shown in FIG. 2, the filter unit 12 may include: a low-pass filter 121, configured to perform low-pass filtering on an input audio signal, and output an audio signal in a first frequency band, so as to filter out a high-frequency component in the input audio signal and allow a low-frequency component to pass; a first power amplifier 123, configured to amplify the audio signal output by the low-pass filter 121, and output the amplified audio signal to a loudspeaker 11, where the loudspeaker 11 plays the audio signal in the first frequency band; a high-pass filter 122, configured to perform high-pass filtering on an input audio signal, and output an audio signal in a second frequency band, so as to filter out a low-frequency component in the input audio signal and allow a high-frequency component to pass; and a second power amplifier 124, configured to amplify the audio signal output by the high-pass filter 122, and output the amplified audio signal to the other loudspeaker 11, where the other loudspeaker 11 plays the audio signal in the second frequency band. The low-pass filter 121 and/or the high-pass filter 122 may be an infinite impulse response digital filter (Infinite Impulse Response, IIR). The first frequency band has a frequency response range of (0, f0], and the second frequency band has a frequency response range of [f1, +∞], where f0 is an upper cut-off frequency of the first frequency band, and f1 is a lower cut-off frequency of the second frequency band.

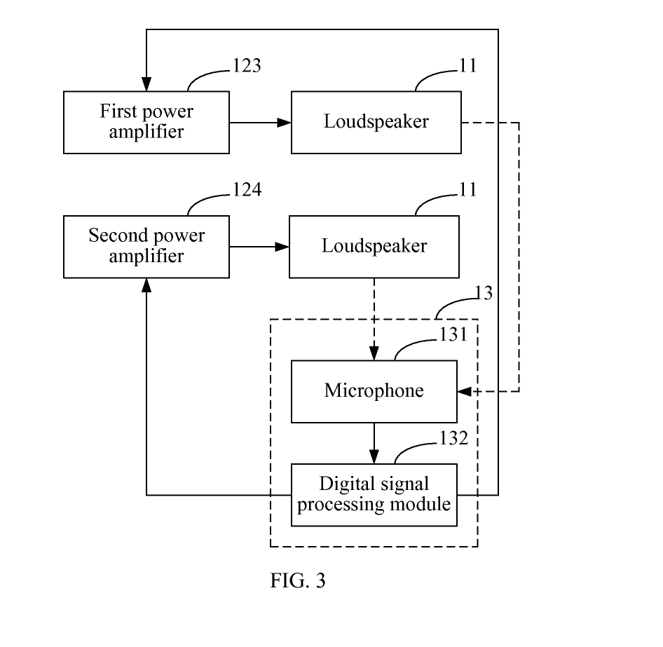

Further, as shown in FIG. 3, the feedback control unit 13 may include: a microphone 131, configured to collect audio signals emitted by the two loudspeakers 11; and a digital signal processing module 132, configured to measure power values of the audio signals collected by the microphone 131 in the second frequency band and in the first frequency band, and adjust, according to a measurement result, an amplification factor of the first power amplifier 123 and/or an amplification factor of the second power amplifier 124.

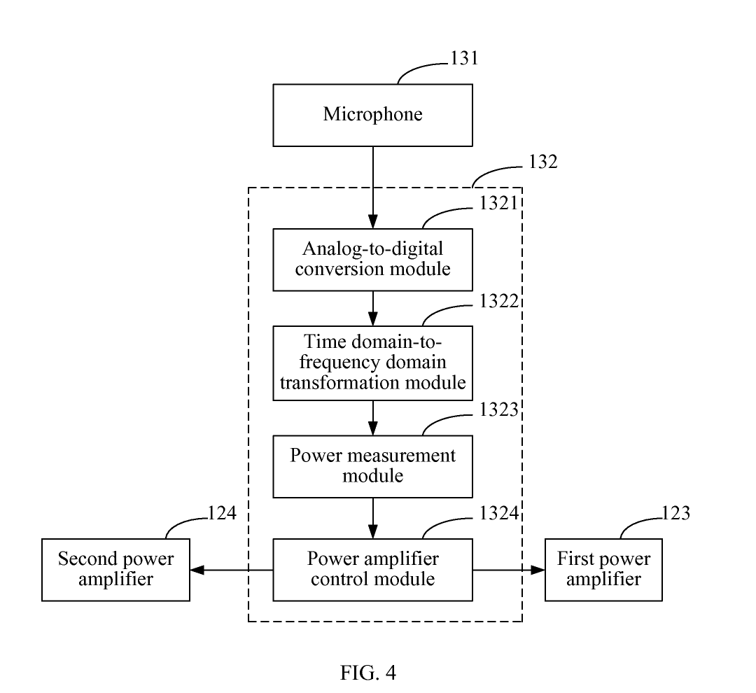

Further, as shown in FIG. 4, the digital signal processing module 132 may further include: an analog-to-digital conversion module 1321, configured to perform analog-to-digital conversion on the audio signals collected by the microphone 131, and output digital audio signals; a time domain-to-frequency domain transformation module 1322, configured to transform, by using a fast Fourier transform algorithm, the digital audio signals output by the analog-to-digital conversion module 1321 from a time domain to a frequency domain, where the digital audio signals are converted from signals changing with time to signals changing with frequency; a power measurement module 1323, configured to measure power values of the digital audio signals transformed by the time domain-to-frequency domain transformation module 1322 in the second frequency band and in the first frequency band; and a power amplifier control module 1324, configured to adjust an amplification factor of the first power amplifier 123 and/or an amplification factor of the second power amplifier 124 according to the power values of the digital audio signals measured by the power measurement module 1323 in the second frequency band and in the first frequency band. When power of a digital audio signal measured by the power measurement module 1323 in the second frequency band is lower than a preset power value of a digital audio signal in the first frequency band, the power amplifier control module 1324 increases the amplification factor of the second power amplifier 124, and when power of a digital audio signal measured by the power measurement module 1323 in the first frequency band is lower than a preset power value of a digital audio signal in the second frequency band, the power amplifier control module 1324 decreases the amplification factor of the second power amplifier 124.

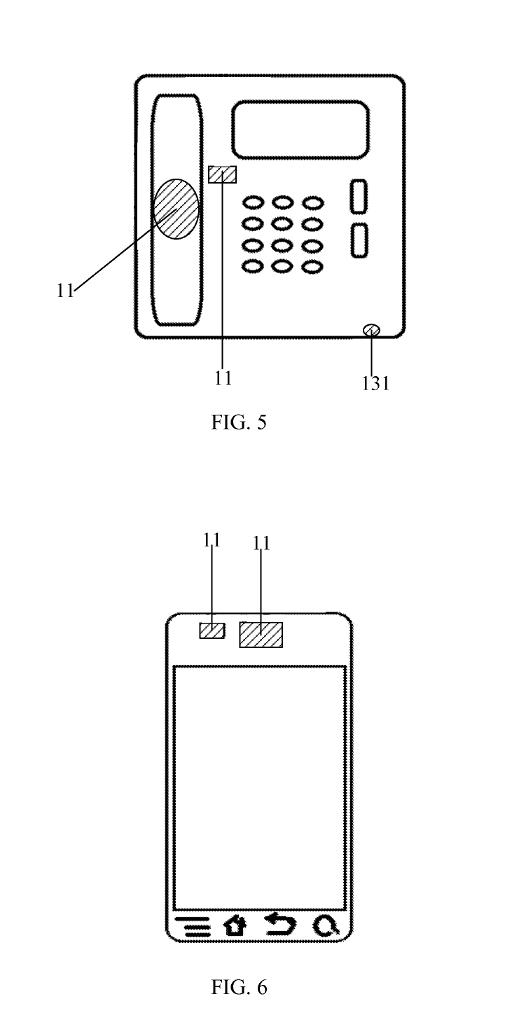

An embodiment of the present invention further provides an electronic device, which includes an audio signal playback system described above. Preferably, the electronic device is a telephone or a mobile communication terminal. FIG. 5 is a schematic diagram illustrating an exterior of the telephone, and FIG. 6 is a schematic diagram illustrating an exterior of the mobile communication terminal. However, the loudspeakers 11 or the microphone 131 may be arranged at any position on a surface of the electronic device, and is not limited to the position shown in FIG. 5 or FIG. 6.

The audio signal playback system provided in the embodiment of the present invention, besides including two or more loudspeakers, further includes a feedback control unit for performing frequency analysis on audio signals emitted by the loudspeakers and adjusting, according to an analysis result, audio playback strength of a corresponding loudspeaker. In this way, feedback control over audio playback strength of the loudspeakers is implemented, so that the loudspeakers have consistent loudness, thereby optimizing the audio playback quality of the system, improving the experience of a listener, and facilitating the promotion and application of a product.

A person of ordinary skill in the art may understand that, all or a part of the steps of the foregoing method in the embodiments may be implemented by a program instructing relevant hardware. The foregoing program may be stored in a computer readable storage medium, such as a ROM/RAM, a magnetic disk, or an optical disc.

The foregoing descriptions are merely exemplary embodiments of the present invention, but not intended to limit the present invention. Any modification, equivalent replacement, and improvement made without departing from the spirit and principle of the present invention shall fall within the protection scope of the present invention.

1. An audio signal playback system, comprising:
two or more loudspeakers, wherein each loudspeaker is configured to play audio signals in a frequency band that is different than a frequency band of the audio signals played in each of the other two or more loudspeakers;
a filter unit, configured to filter an input audio signal, amplify the filtered audio signal, and output the amplified and filtered audio signal to the two or more loudspeakers; and
a feedback control unit, configured to collect the audio signals played by the two or more loudspeakers, measure power values of the collected audio signals in different frequency bands, and adjust, according to a measurement result, an amplification factor of the filter unit for the filtered audio signal in a corresponding frequency band.

2. The audio signal playback system according to claim 1, wherein the filter unit comprises:
two or more filters, configured to separately filter an input audio signal, and output the filtered audio signal; and
two or more power amplifiers, wherein the two or more power amplifiers are separately located between the filters and loudspeakers, and are configured to amplify the audio signals output by the corresponding filters, and output the amplified audio signals to the corresponding loudspeakers.

3. The audio signal playback system according to claim 2, wherein the system comprises two loudspeakers, and the filter unit comprises:
a low-pass filter, configured to perform low-pass filtering on an input audio signal, and output an audio signal in a first frequency band;
a first power amplifier, configured to amplify the audio signal in the first frequency band that is output by the low-pass filter, and output the amplified audio signal in the first frequency band to a loudspeaker;
a high-pass filter, configured to perform high-pass filtering on an input audio signal, and output an audio signal in a second frequency band; and
a second power amplifier, configured to amplify the audio signal in the second frequency band that is output by the high-pass filter, and output the amplified audio signal in the second frequency band to the other loudspeaker,
wherein the first frequency band has a frequency response range of (0, f0], and the second frequency band has a frequency response range of [f1, +∞], wherein f0 is an upper cut-off frequency of the first frequency band, and f1 is a lower cut-off frequency of the second frequency band.

4. The audio signal playback system according to claim 3, wherein at least one of the low-pass filter and the high-pass filter is an infinite impulse response digital filter.

5. The audio signal playback system according to claim 3, wherein the feedback control unit comprises:
a microphone, configured to collect audio signals emitted by the two loudspeakers; and
a digital signal processing module, configured to measure power values of the audio signals collected by the microphone in the second frequency band and in the first frequency band, and adjust, according to a measurement result, an amplification factor of the first power amplifier and/or an amplification factor of the second power amplifier.

6. The audio signal playback system according to claim 5, wherein the digital signal processing module comprises:
an analog-to-digital conversion module, configured to perform analog-to-digital conversion on the audio signals collected by the microphone, and output digital audio signals;
a time domain-to-frequency domain transformation module, configured to transform, by using a fast Fourier transform algorithm, the digital audio signals output by the analog-to-digital conversion module from a time domain to a frequency domain;
a power measurement module, configured to measure power values of the digital audio signals transformed by the time domain-to-frequency domain transformation module in the second frequency band and in the first frequency band; and
a power amplifier control module, configured to adjust an amplification factor of the first power amplifier and/or an amplification factor of the second power amplifier according to the power values of the digital audio signals measured by the power measurement module in the second frequency band and in the first frequency band.

7. The audio signal playback system according to claim 6, wherein when power of a digital audio signal measured by the power measurement module in the second frequency band is lower than a preset power value of a digital audio signal in the first frequency band, the power amplifier control module increases the amplification factor of the second power amplifier; and
when power of a digital audio signal measured by the power measurement module in the first frequency band is lower than a preset power value of a digital audio signal in the second frequency band, the power amplifier control module decreases the amplification factor of the second power amplifier.

8. An electronic device, comprising an audio signal playback system that includes:
two or more loudspeakers, wherein each loudspeaker is configured to play audio signals in a frequency band that is different than a frequency band of the audio signals played in each of the other two or more loudspeakers,
a filter unit, configured to filter an input audio signal, amplify the filtered audio signal, and output the amplified and filtered audio signal to the two or more loudspeakers, and
a feedback control unit, configured to collect the audio signals played by the two or more loudspeakers, measure power values of the collected audio signals in different frequency bands, and adjust, according to a measurement result, an amplification factor of the filter unit for the filtered audio signal in a corresponding frequency band.

9. The electronic device according to claim 8, wherein the electronic device is a telephone or a mobile communication terminal.
